(19) United States
(12) Patent Application Publication
(10) Pub. No.: US 2021/0398143 A1
(43) Pub. Date: Dec. 23, 2021

(54) SYSTEMS AND METHODS FOR PUBLIC-FACING ACCREDITATION USING FINANCIAL INSTITUION DATA

(71) Applicant: Capital One Services, LLC, McLean, VA (US)

(72) Inventor: Kevin PARK, New York, NY (US)

(73) Assignee: Capital One Services, LLC, McLean, VA (US)

(21) Appl. No.: 16/905,353

(22) Filed: Jun. 18, 2020

(51) Int. Cl. G06Q 30/00; G06Q 50/00; G06Q 40/02; H04L 29/06; G06F 16/23; G06N 20/00; G06N 5/04

(52) U.S. Cl. CPC G06Q 30/0185; G06Q 50/01; G06Q 40/025; G06N 5/04; H04L 63/08; G06F 16/2365; G06N 20/00; H04L 63/105

(57) ABSTRACT

Disclosed are systems and methods for validating institutional or individual credentials and generating public facing electronic insignias representative of the validated credentials. Financial institutions maintain vast amounts of data regarding customers, and in particular data relating to financial history and performance. The disclosed systems and methods provide a novel framework for leveraging such data in order to generate and/or validate credential data. In some embodiments, an immutable ledger maintained at one or more databases in communication with financial institutions may store electronic credential records regarding an institution or individual that can be analyzed and accessed in order to assign an entity to a specific accreditation tier.

### TECHNICAL FIELD

Various embodiments of the present disclosure relate generally to accreditation of individuals and/or institutions, using financial institution information.

### BACKGROUND

Institutions (e.g. educational institutions, charities, nonprofits, etc.) and individuals (e.g., institution representatives, customers, candidates, or other individuals affiliated or not affiliated with an institution) can underestimate, under-represent, embellish or exaggerate their financial performance, aptitude, credentials, and/or titles online or on paper, such as via social media, in applications, proposals, and the like. Third party auditors, organizations and/or individuals interested in establishing a relationship with an institution or individual may require correct knowledge of, or express interest in, the financial standing, performance, prospects, or ability of the institution or individual. Additionally, the institution or individual may consider the details of such information to be private and/or confidential. As custodians for most transactions, financial institutions have access to, e.g., spending data, income, balance levels, credit scores, and other financial information that can help to accurately indicate the financial status or other credentials of said institution or individual. However, the financial industry lacks systems and methods for synthesizing the financial information with other information about the institution or individual, to produce conclusions or characterizations about the institution or individual suitable for public display and useful to third parties.

The background description provided herein is for the purpose of generally presenting the context of the disclosure. Unless otherwise indicated herein, the materials described in this section are not prior art to the claims in this application and are not admitted to be prior art, or suggestions of the prior art, by inclusion in this section.

### SUMMARY

According to certain aspects of the disclosure, systems and methods are disclosed for validating institutional or individual credentials and generating public facing electronic insignias representative of the validated credentials.

For instance, a method may include receiving, at one or more first servers, an electronic application from a client device corresponding to a user; comparing user data points of the electronic application to electronic records corresponding to the user stored in at least one database to generate a credential score of the user; associating the credential score with one tier of a plurality of tiers, and assigning the user to the one tier of the plurality of tiers; transmitting an electronic notification to the client device reporting the one tier of the plurality of tiers to which the user has been assigned; generating and assigning an electronic insignia to the user, wherein the insignia is indicative of the one tier of the plurality of tiers to which the user has been assigned; receiving a request for the electronic credentials assigned to the user from a requesting party; and transmitting the electronic insignia to the requesting party.

For instance, another method may include receiving, at one or more first servers, an electronic application and authentication credentials from a client device corresponding to a user; determining whether the authentication credentials are valid and querying at least one database storing electronic records corresponding to the user upon determining that the authentication credentials are valid; validating data points of the electronic application by comparing the data points to the electronic records corresponding to the user; generating a credential score based on the validated data points by inputting the validated data points into a certification model and further associating the credential score with the user; associating the credential score with one tier of a plurality of tiers of credential scores and assigning the user to the one tier of the plurality of tiers; and transmitting an electronic notification to the client device reporting the one tier of the plurality of tiers to which the user has been assigned.

Furthermore, a computer system may include a storage device that stores instructions; and at least one processor that executes instructions for: receiving, at one or more first servers, an electronic application and authentication credentials from a client device corresponding to a user; determining whether the authentication credentials are valid and querying at least one database storing electronic records corresponding to the user upon determining that the authentication credentials are valid; validating data points of the electronic application by comparing the data points to the electronic records corresponding to the user stored in the at least one database; generating a credential score based on the validated data points by inputting the validated data points into a certification model and further associating the credential score with the user; associating the credential score with one tier of a plurality of tiers and assigning the user to the one tier of a plurality of tiers; storing data corresponding to the assigned tier in the at least one database and one or more second databases networked with the at least one database via a decentralized blockchain; and transmitting an electronic notification to the client device reporting the one tier of the plurality of tiers to which the user has been assigned.

According to additional aspects of the disclosure, a non-transitory computer-readable medium stores instructions that, when executed by one or more processors, cause the one or more processors to perform the aforementioned computer-implemented method or the operations that the aforementioned computer systems are configured to perform.

It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute a part of this specification, illustrate various exemplary embodiments, and together with the description, serve to explain the principles of the disclosed embodiments.

FIG. 1 depicts an exemplary system infrastructure, according to one or more embodiments.

FIG. 2 depicts a data flow diagram of an exemplary system and method of electronic credential validation and generation of an electronic insignia representative of the validated credentials, according to one or more embodiments.

FIG. 3 depicts a flowchart of an exemplary method of electronic credential validation, according to one or more embodiments.

FIG. 4 depicts a flowchart of an exemplary method for electronic credential validation, according to one or more embodiments.

FIG. 5 depicts an example of a computing device, according to one or more embodiments.

There are many embodiments described and illustrated herein. The present disclosure is not limited to any single aspect or embodiment thereof, nor to any combinations and/or permutations of such aspects and/or embodiments. Each of the aspects of the present disclosure, and/or embodiments thereof, may be employed alone or in combination with one or more of the other aspects of the present disclosure and/or embodiments thereof. For the sake of brevity, many of those combinations and permutations are not discussed separately herein.

### DETAILED DESCRIPTION

The terminology used below may be interpreted in its broadest reasonable manner, even though it is being used in conjunction with a detailed description of certain specific examples of the present disclosure. Indeed, certain terms may even be emphasized below; however, any terminology intended to be interpreted in any restricted manner will be overtly and specifically defined as such in this Detailed Description section. Both the foregoing general description and the following detailed description are exemplary and explanatory only and are not restrictive of the features as claimed.

In this disclosure, the term “based on” means “based at least in part on.” The singular forms “a,” “an,” and “the” include plural referents unless the context dictates otherwise. The term “exemplary” is used in the sense of “example” rather than “ideal.” The terms “comprises,” “comprising,” “includes,” “including,” or other variations thereof, are intended to cover a non-exclusive inclusion such that a process, method, or product that comprises a list of elements does not necessarily include only those elements, but may include other elements not expressly listed or inherent to such a process, method, article, or apparatus. Relative terms, such as, “substantially,” “about,” “approximately,” and “generally,” are used to indicate a possible variation of ±10% of a stated or understood value.

The term “credential(s)” may refer to an indicator or metric summarizing or indicating one or more of financial stability, reliability, financial capacity, financial liquidity, institution health, reputation (e.g., institution or individual reputation), institution longevity, representative titles (e.g. chief executive office, general counsel, chief technology officer, etc.), certifications (e.g., board certification, borrower certification, etc.), or other indicators of reliability, stability, trustworthiness, status, or health. The term “validation” may refer to methods for comparing credentials promoted via social media or other received credentials to known credentials. The term “validation” may further refer to methods for verifying credentials or data via an algorithm, and/or determining identifying information of an institution device (e.g. IP address or GPS location) and/or an institution representative.

The term “electronic insignia” may refer to any electronic indicator serving as summation of an institution or individual's validated credentials. In some embodiments, for example, an electronic insignia may indicate a ranking or a tier assigned to an institution or individual based on their validated credentials. In some embodiments, an electronic insignia may be an electronic visual insignia, such as a digital image (e.g., a digital icon, badge, token, photograph, or the like), a number, a letter (e.g., a letter grade), a color indicator (e.g., a digital bar, stripe, icon, badge, or token having a gold, silver, bronze, black, red, or any other color indicating a tier or relative ranking), a number of tokens (e.g., stars, dots, check marks, etc.) where the number of token indicates a tier or relative ranking, or any other visual item suitable for inclusion on an electronic interface, such as a website, social media page, electronic resume, or the like. As another example, an electronic insignia may include a verification key (e.g., embedded in the code of an electronic interface), a pointer to a blockchain node, or any other code or code fragment that may provide a non-visual summation of validated credentials. For example, an electronic insignia may serve as a “passcode” or “key” to allowing an institution or individual's information to be transmitted or displayed on a website or other interface.

In the following description, embodiments will be described with reference to the accompanying drawings. As will be discussed in more detail below, in various embodiments, data, such as transactional data, may be used in evaluating credentials of an institution or individual. Evaluating the credentials of an institution or individual may include validating the credentials by comparing received credentials (e.g. credentials submitted via an application) to known data points associated with the institution or individual (e.g., from secure, accredited, verified, or otherwise approved sources). Following evaluation of the financial characteristics of the institution or individual, the institution or individual may receive a title, ranking, and/or electronic insignia indicative of the credentials being validated.

Some implementations described herein may provide credential generation and/or validation using blockchain technology. For example, institutions or individuals may request credential generation or validation from a network of one or more financial institution validation servers (e.g., a bank operating computing devices serving as nodes in a blockchain network). A validation server may receive an application to validate credentials from an institution or individual, wherein the institution or individual may provide identifying data such as a name, one or more credentials, financial data, representative information, and/or other identifying data, and said identifying data may be transmitted with blockchain consensus protocols, such as proof of work, proof of stake, proof of activity, proof of burn (or other algorithms responsible for verifying and validating blockchain transactions, and keeping the network secure), a hash value or other indicia. The validation server may then execute a validation process to retrieve and assess the validity of the credentials, and store data indicative of a validation result along with storing a hash (or other indicia) and storing a key associated with the validation server assessing the validity (e.g., for identification, traceability, known financial data, and/or the like). The validation server may append a transaction including the aforementioned information to a block of a credential validation blockchain network, where after determining consensus amongst other credential validation nodes, the transaction may become an immutable inclusion in the blockchain. The blockchain may include a variety of information, including identifying information that is representative of the institution or individual associated with the application, and/or validation information that verifies or corroborates the trustworthiness, validity, reliability, legitimacy, accuracy, etc., of the institution- or individual-provided credentials. For example, the validation information may include an application, a smart contract, instructions, an algorithm, a process, and/or the like, which may specify a method used for validating the credentials as being either accurate or inaccurate (or some measure or degree of accuracy), trusted/valid data points, or the like.

Additionally or alternatively, institutions or individuals may request generation of an electronic insignia representative of an institution's or individual's validated credentials from a network of one or more validation servers. A validation server may receive an application to generate an electronic insignia for an institution or individual, wherein the institution or individual (or another party) may provide credentials and/or other identifying data (e.g. a name, representative information, application data, certifications, financial data, property holdings information, and/or any other data that may show reliability, trustworthiness, status, financial health, etc.). As described further below and in reference to the figures, once the institution's or individual's credentials are validated, the credentials are then scored and assigned to a tier representative of the score. For example, one or more score-calculation algorithms, may weigh and interpret credentials (e.g., financial data) regarding a user (e.g., an institution or an individual) and assign a weight to data points (e.g., based on value of assets, accurateness of disclosed information, debt-to-income ratio, etc.) associated with an institution or individual and generate a score for the institution or individual based on the sum of the weights assigned to each data point and based on the score exceeding a (predetermined) threshold, further assign the institution or individual to a tier (e.g., platinum, gold, silver, or the like) representative of its score. In this example, each tier may be associated with a numeric value and additionally associated with a threshold. Each tier may be additionally ranked, for example, a platinum tier may be associated with a higher numeric value and threshold than a gold or silver tier, and therefore may be ranked higher. An electronic insignia may be generated. The electronic insignia may be representative of a tier (e.g., platinum, gold, and/or silver, first, second, and/or third, or the like) and may be configured to be transmitted to a computing device associated with an individual or institution, or made available to third party applications, such as, social media applications via API requests. The electronic insignia assigned to the institution may also be recorded in a log on the blockchain network across several nodes. Maintaining access to the electronic insignia may require an institution or individual to maintain assignment to at least one tier of the plurality of tiers. For example, an institution or individual's whose credentials fall below a certain threshold or fail to align with known data points about the institution or individual may be demoted to a lower tier or unassigned a tier. Similarly, if an institution or individual's credentials increase beyond a certain threshold, the institution or individual may be assigned to a higher tier. In some embodiments, access to a given tier (or to an electronic insignia indicative of the tier) may grant an institution or individual access to a given platform, such as a web platform, a type of social media platform, or the like. In such cases, maintaining access to the platform may require the institution or individual to maintain assignment to the given tier.

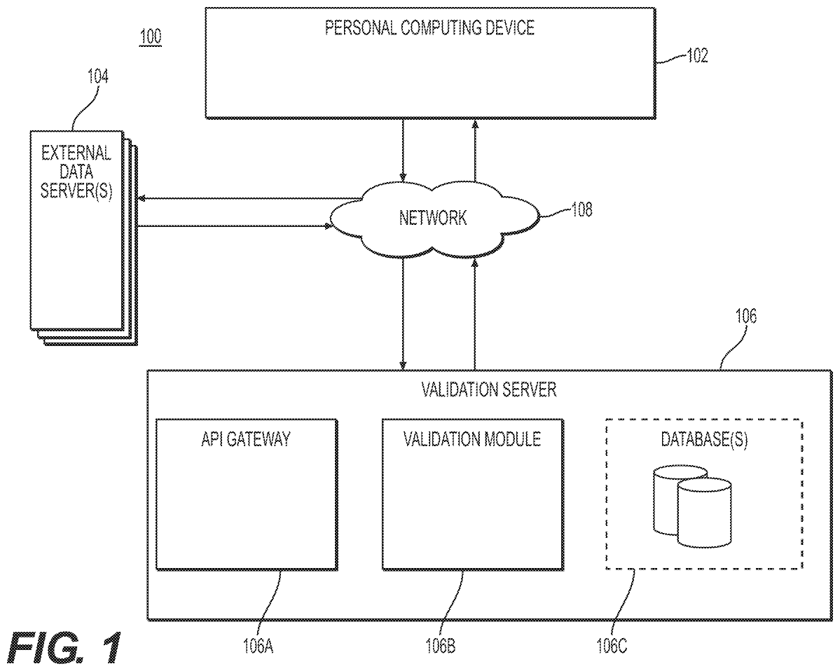

FIG. 1 is a diagram depicting an example of a system environment 100 according to one or more embodiments of the present disclosure. The system environment 100 may include a personal computing device 102, (an) external data server(s) 104, and a validation server 106. These components may be connected to one another by a network 108. In some embodiments, two or more components in the system environment 100 may further be linked together by an open or member-only decentralized distributed ledger, for example, a blockchain.

The personal computing device 102 may have one or more processors configured to perform methods described in this disclosure. An institution (e.g., a merchant, business, educational institution, nonprofit, or service/product provider) or an individual (e.g., a representative of the institution, such as a CEO, CFO, owner, or employee, or a person unaffiliated with an institution) may be a user operating the personal computing device 102 (which also may be known as a user device or client device). The personal computing device 102 may be any electronic device allowing for interaction with a user interface, such as a mobile phone, a laptop computer, a landline phone, a desktop computer, a gaming system, a television, smart accessory, and/or a digital or artificial intelligence enabled personal assistant. The personal computing device 102 may include an operating system, one or more applications, and/or one or more internet browsers configured to implement one or more embodiments herein. In some embodiments the personal computing device 102 may also communicate with other components on the system environment 100. For example, the personal computing device 102 may access the network 108 to communicate with the external data server(s) 104 or the validation server 106. The personal computing device 102 may be configured for receiving and sending signals via a wireless or wired network, and may be further configured for storing data in physical memory. The personal computing device 102 may also be configured to store data in physical memory or in one or more databases as a standalone local process and/or in unison with other components on the network 108 via an open or member-only decentralized distributed ledger (e.g., a blockchain protocol). For example, an institution or individual operating a personal computing device 102 may complete a credential application and transmit a request to a validation server 106 via the network 108, and the transmitted request may be sent as a blockchain entry for securely sending the request to the institutions server systems 110. In some instances, a hash function, or hashing algorithm (e.g., Secure Hashing Algorithm 256), may be used to cryptographically encrypt the query request into a series of numbers and letters that does not resemble the original data of the query request (e.g., does not resemble the question and/or numerical code for the query request).

In some embodiments, an institution may be an entity that provides products or services. In this disclosure, the term “product,” in the context of products offered by an institution, may encompass both goods and services, as well as products that are a combination of goods and services. An institution may be, for example, a retailer, a grocery store, an educational institution, a non-profit organization, a charity, an entertainment venue, a service provider, a restaurant, a bar, a non-profit organization, or other type of entity that provides services or products that a consumer or other recipient may receive. In some embodiments, an institution may have one or more venues that a consumer physically visits in order to obtain the products (goods or services) offered by the merchant. In this context, a venue may be a facility such as a “brick-and-mortar” store. An institution representative may be any individual that works, owns, is an agent for, or is a stakeholder in the business. In some embodiments, an institution may have a digital storefront, for example, an online store where goods and services are made available via a website.

In some embodiments, an individual may be, for example, an executive, an employee, owner, agent, or representative of an institution, or an individual independent of an institution. Similar to an institution, an individual may have credentials that can be validated, for example, the individual's title at an institution, the individual's financial health (e.g. cash holdings, debt, income, property, years of experience), certifications or admissions held by the individual (e.g., board certifications, bar admissions, membership in institutions, groups, clubs, or the like), and/or the individual's credit score, etc.

The external data server(s) 104 may include one or more servers, desktop computers, multiprocessor systems, databases(s), sub-networks, programmable electronics, and the like, maintained by third parties (e.g. financial institutions, credit bureaus, government agencies, product/service providers, etc.) storing business-to-business or business-to-consumer data. In some embodiments, the external data server(s) 104 may include data that is, e.g., verified, validated, certified, secure, or otherwise known to be checked for accuracy and/or made resistant to tampering or falsification. The validation server 106 may communicate with and/or receive data stored on the external data server(s) 104. The data stored on the external data server(s) 104 may include, but is not limited to, information related to: certifications, incorporation information, background check information, financial data, credit/debit card balance, amount of spend, default rate, pay back rate, vendor types, loan information, frequency of borrowing, account balance, debit/deposit information, credit score, and pay back rate. The validation server 106 may be able to parse the aforementioned data from the external data server(s) 104 and/or additionally send or receive blockchain entry information to and/or from the validation server 106. Creating a new blockchain entry or reading an existing blockchain entry may require creating or solving a cryptographic hash corresponding to the block chain entry. In some embodiments, the external data server(s) 104 may either create or read a blockchain entry.

The validation server 106 may include an Application Programming Interface (API) gateway 106A, a validation module 106B, and one or more database(s) 106C. Although not shown, the validation server 106 may further include one or more communication servers, web servers, application servers, proxy servers, collaboration servers, or the like. The validation server 106 may be configured to execute one or more score-calculation algorithms, which weigh and interpret data points (e.g., financial data) regarding a user (e.g., an institution or individual) to, e.g., generate credentials for the user. The API gateway 106A may be configured to communicate with one or more devices on the network 108 and or components of validation server 106 to manage API calls from applications and/or devices requesting to access the network 108, access data stored on a component of the network 108 (e.g., external data server(s) 104 and/or personal computing device 102), and/or create or read a blockchain entry. The API gateway 106A may be further configured to allow users (e.g., individuals or institutions) to share a generated/validated credential, user information, and/or electronic insignia on a webpage, a software application, or on social media (e.g., displaying a social media badge on LinkedIn, Facebook, WeChat, Github, Twitter, etc.) after exchanging proxy keys. The API gateway 106A may further be configured to screen or provide instructions to validation server 106 components to monitor requests for malicious access requests and/or non-compliant blockchain protocol entries. The API gateway 106A may further detect and implement instructions for updating databases or ledgers on components of system 100 that may have been identified as having been comprised by malicious inputs, or that may be maintaining blockchain entries that do not match logs held at other components maintaining corresponding blockchain entries.

The validation module 106B may be configured to implement instructions for validating credentials of a user (e.g., an individual or institution). In some embodiments, the validation module 106B may be configured to specifically compare an institution or individual's credentials promoted via social media or credentials received from the institution or individual (e.g., in an application), to credentials already known about the institution or individual. The validation module 1066 may additionally verify credentials via an algorithm, and/or determine identifying information of an institution/individual device (e.g. IP address or GPS location) and/or an institution representative. For example, upon the validation server receiving an application to certify credentials from an institution or individual, the validation module 106B may parse the received application for identifying data such as name, financial data, institution representative information, certifications received, demographic information, geographic information, property data and/or asset information; and may determine whether the received transmission corresponding to the received application is in compliance with blockchain consensus protocols, such as a hash value or other indicia. The validation module 1066 may also be configured to execute one or more score-calculation algorithms, which weigh and interpret data points (e.g., financial data) regarding a user (e.g., an institution or an individual). For example, the validation module 106B may assign a weight to data points (e.g., based on value of assets, accurateness of disclosed information, type of disclosed information, debt-to-income ratio, or the like) associated with an institution or individual and generate a score for the institution or individual based on the sum of the weights assigned to each data point. The weight assigned to data points may be predetermined (e.g., by programming), may be based on a relative importance of the data points, and/or may be determined based on a machine learning or other model. Based on the score exceeding a threshold (e.g., a predetermined threshold), the validation module 106B may further assign the institution or individual to a tier (e.g., platinum, gold, silver, or the like) representative of its score. In this example, each tier may be associated with a numeric value and additionally associated with a threshold. Each tier may be additionally ranked, for example, a platinum tier may be associated with a higher numeric value and threshold than a gold or silver tier, and therefore may be ranked higher. The validation module 106B may additionally log each request to create, update, and/or access user(s) (e.g., an institution or individual) credentials in a self-referential database and/or blockchain entry in order to maintain a decentralized and immutable record of the user's credentials and access to them.

The validation server 106 may include one or more databases 106C. The databases 106C may be configured to store data including, but not limited to, information related to validation, such as: financial data, credit/debit card balance, amount of spend, default rate, pay back rate, vendor types, loan information, frequency of borrowing, account balance, debit/deposit information, credit score, user (e.g., business) social media data, user (e.g., business) tier information, pay back rate, certifications, admissions, memberships, etc. The databases 106C may be local to the validation server 106 or may be housed in a separate physical location. The databases 106C may include any suitable database structure, such as a relational database, object-oriented database, and/or a hierarchal database. In some instances the databases 106C may include a self-referential database. For example, if the databases 106C receive new input into one or more rows, columns to support the one or more rows may be automatically generated. Furthermore, the databases 106C may comply with blockchain consensus protocols and as such may be updated or amended to mirror data stored in the external data server(s) 104 or on a personal computing device 102. The one or more databases 106C may be physically and geographically located in a single or different locations. While the one or more databases 106C may receive data from non-local, unsecure public sources as well as secure sources containing confidential information (e.g. external data server(s) 104), the one or more databases 106C may encrypt the data stored therein. The validation server 106 may be configured to synthesize the data stored on the one or more databases 106C in furtherance of one or more functions discussed herein, thereby making use of both unsecure and confidential information to generate and/or validate credentials.

The network 108 may be any suitable network or combination of networks and may support any appropriate protocol suitable for communication of data to and from the validation server 106 and between various other components in the system environment 100. For example, the network 108 may include a public network (e.g., the internet), a private network (e.g., a network within an organization), or a combination of public and/or private networks. In some embodiments, the network 108 may also be configured to facilitate and/or accommodate various blockchain protocols.

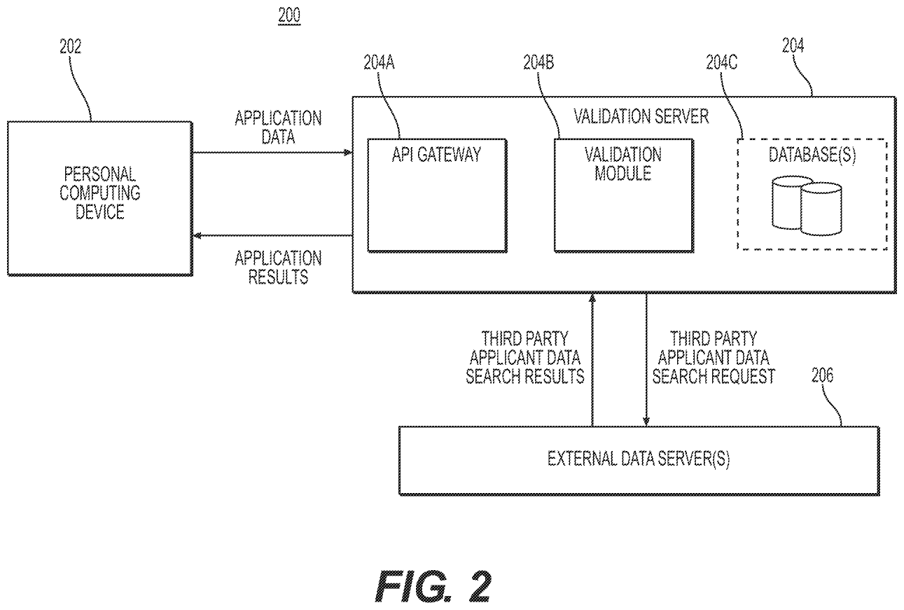

FIG. 2 depicts a data flow diagram of an exemplary system and method 200 for electronic credential validation based on similar components as disclosed in FIG. 1. Components shown in FIG. 2 may share any characteristics with the similarly-named components in FIG. 1. For example, the personal computing device 202 may share any characteristics with the personal computing device 102, the validation server 204 and its components 204A, 204B, and 204C may share any characteristics with the validation server 106 and its components 106A, 106B, and 106C respectively, and the external data server(s) 206 may share any characteristics with the external data server(s) 104. The personal computing device 202 may receive an application for credential certification from an individual or institution via, e.g., a user interface. The personal computing device 202 may transmit the application data to the validation server 204 along with API proxy keys or tokens to be validated. The validation server 204, via the API gateway 204A, may authenticate the received transmission by comparing the received proxy keys or tokens to proxy keys and/or tokens stored at the validation server 204. If the received transmission is authenticated, the validation module 204B may assign a weight to data points identified in the received application and generate a score for the institution or individual based on the sum of the weights assigned to each data point (e.g. based value of assets, accurateness of disclosed information, debt-to-income ratio, or other basis) and based on the score exceeding a (predetermined) threshold; the validation module 204B may additionally assign the institution or individual to a tier (e.g., platinum, gold, silver, or the like) representative of its score. The tier may be associated with, e.g., an electronic insignia that may be output (e.g., to the personal computing device 202 or to another output location). During the aforementioned step the validation module 204B may compare the data points from the received application to the known data points stored in one or more databases 204C or external data server(s) 206. The validation module 204B may communicate with database(s) 204C to compare the received application data to data previously stored in the validation server 204 or to create a new entry in or to store new or updated information regarding the institution or individual. Additionally, the database(s) 204C may be configured to receive and store blockchain entries and maintain logs corresponding to requests to access blockchain entries. The validation server 204 may additionally initiate queries, for example a third party applicant data search request, to the external data server(s) 206 to receive information regarding a user (e.g., an institution or individual) including, but is not limited to, information related to: financial data, credit/debit card balance, amount of spend, default rate, pay back rate, vendor types, loan information, frequency of borrowing, account balance, debit/deposit information, credit score, and pay back rate. The validation server 204 may be able to parse the aforementioned data from the external data server(s) 206 and/or additionally send or receive blockchain entry information. Creating a new blockchain entry or reading an existing blockchain entry may require creating or solving a cryptographic hash corresponding to the block chain entry. In response to receiving a third party application data search request, the external data server(s) 206 may transmit third party application data search results to the validation server 204. The validation server 204 may analyze the received third party application data search results and assign weight to data points corresponding to the institution or individual in furtherance of score-calculation algorithms. The validation server 204 may then transmit application results to the personal computing device 202.

In some embodiments, the aforementioned steps may be repeated to, e.g., update validation of credentials and/or re-generate or revise a credential score and/or an electronic insignia for an individual or institution.

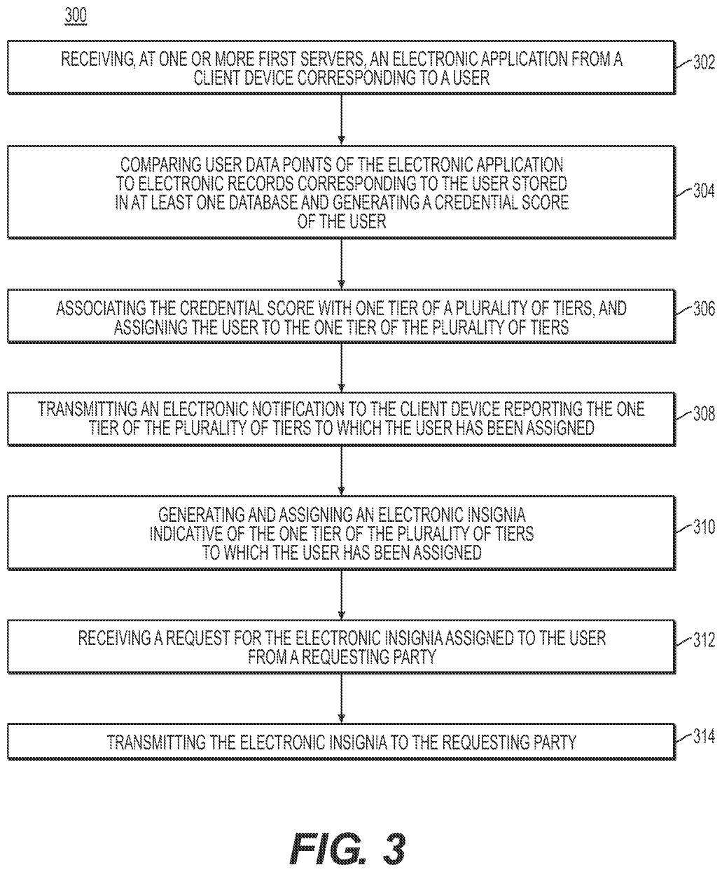

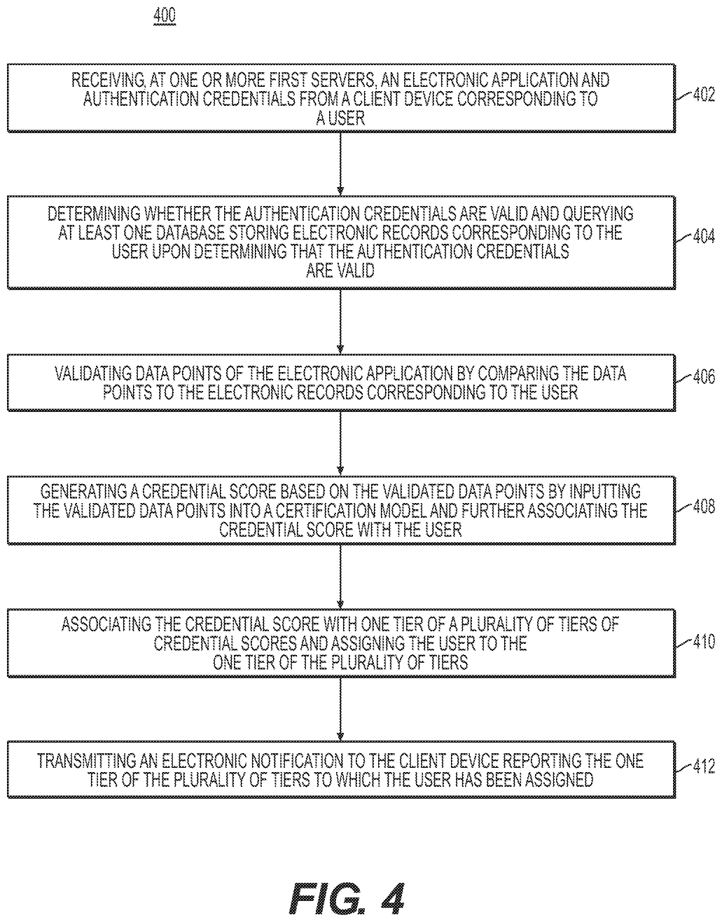

Reference will now be made to the methods 300, 400 depicted in FIGS. 3 and 4. While the methods may be described with respect to the components of, e.g., the system 100, it is contemplated that the methods may be executed using the components and/or steps described with respect to system and method 200, or any other suitable system. Additionally, any or all of the steps of the below-referenced methods 300, 400 may be repeated to, e.g., update validation of credentials and/or re-generate or revise a credential score and/or an electronic insignia for a user (e.g., an individual or institution).

FIG. 3 depicts a flowchart of an exemplary method 300 of electronic credential generation. The validation server 106 may receive, at one or more first servers, an electronic application from a personal computing device 102 corresponding to a user (e.g. an institution or individual) (Step 302). For example, an institution or individual may complete an application comprising various identifying information or data points on a personal computing device 102 and transmit the application to a validation server 106 to have the application analyzed and validated. The validation server 106 may extract data points from the application (e.g., identifying information, purported credentials and/or certifications, asserted financial data, etc.). In some embodiments, the validation server may receive and validate the information in the application, as has been described with respect to the validation servers 106 and 204. The validation server 106 may compare the data points to electronic records corresponding to the user stored in at least one database (e.g. database(s) 106C) (e.g., to validate the data points), and/or may combine data points of the electronic application with data points from electronic records corresponding to the user, to generate a credential score of the user (Step 304). For example, the validation server may compare the data inputted on the application to information associated with the institution or individual stored at a database 106C in communication with the validation server 106. The validation server 106 may associate the credential score with one tier of a plurality of tiers, and assign the user to the one tier of the plurality of tiers (Step 306). For example, the validation server 106 may execute one or more score-calculation algorithms, which weigh and interpret data points (e.g., financial or other data) regarding an institution or individual and assign a score to the institution or individual, which may be used to further assign the institution or individual to a specific tier. In this example, the validation server 106 may additionally compare the data points to stored data points, in order to weigh data and assign a score. The validation server 106 may additionally store data corresponding to the assigned tier in the a database 106C and one or more second databases networked with the at least one database via a decentralized blockchain. The validation server 106 may then transmit an electronic notification to the client device (e.g., personal computing device 102) reporting the one tier of the plurality of tiers to which the user has been assigned (Step 308). The validation server 106 may generate and assign an electronic insignia indicative of the one tier of the plurality of tiers to which the user has been assigned (Step 310). For example, the validation server may generate an electronic insignia that can be transmitted to the personal computing device 102 of the user (e.g. institution/individual) or made available to third party applications, such as, social media applications, via API requests, visual cryptography techniques, image theft techniques (e.g. watermarking visuals until a secure exchange between sources is created, preventing downloads via code, and hiding images) and/or other methods preserving their security. Here, the electronic insignia may symbolize and communicate to a viewer a holistic representation of the institution's financial well-being without exposing the institution's confidential information. Additionally or alternatively, the validation server 106 may receive a request for the electronic insignia assigned to the user from a requesting party (Step 312). For example, a third party, such as another institution or individual, or a social media application, may request the electronic insignia. The validation server may then transmit the electronic insignia to the requesting party (Step 314).

FIG. 4 depicts a flowchart of an exemplary method of electronic credential validation, according to one or more embodiments. The validation server 106 may receive, at one or more first servers, an electronic application and authentication credentials from a client device corresponding to a user (e.g. an institution or individual) (Step 402). For example, an individual or institution may complete an application comprising various identifying information on a personal computing device and transmit the application, along with proxy keys (or an API token) to a validation server to have the data points in the application analyzed and validated. The validation server 106 may then determine whether the authentication credentials are valid, and query at least one database 106C storing electronic records corresponding to the user upon determining that the authentication credentials are valid (Step 404). The validation server 106 may validate the data points of the electronic application by comparing the data points to the electronic records corresponding to the user (Step 406). For example, the validation server 106 may compare the data inputted on the application to information associated with the institution or individual stored at a database (e.g. database 106C and/or external data server(s) 104) in communication with the validation server 106. The validation server 106 may additionally generate a credential score based on the validated data points by inputting the validated data points into a certification model and further associating the credential score with the user (Step 408). In implementing the certification model the validation server 106 may execute one or more score-calculation algorithms, which may weigh and interpret data points (e.g., financial data) regarding the user. The validation server 106 may then associate the credential score with one tier of a plurality of tiers of credential scores and assign the user to the one tier of the plurality of tiers (Step 410). For example, the validation server 106 may assign a score to the user, which may be used to further assign the user to a specific tier. The validation server 106 may additionally store data corresponding to the assigned tier in the a database 204C and one or more second databases networked with the at least one database via a decentralized blockchain. The validation server 106 may transmit an electronic notification to the client device reporting the one tier of the plurality of tiers to which the user has been assigned (Step 412). For example, the validation server may generate an electronic insignia representative of a tier (e.g., platinum, gold, and/or silver or the like) that can be transmitted to a personal computing device 102 of the user (e.g. individual or institution), or made available to third party applications, such as, social media applications via API requests.

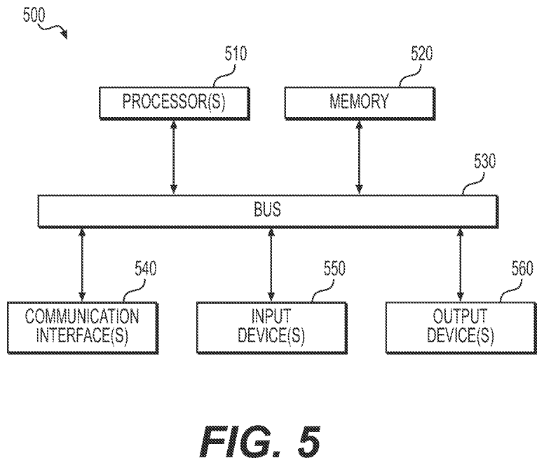

FIG. 5 depicts an example of a computing device 500, which may be used in conjunction with one or more embodiments of the present disclosure. For example, aspects of the computing device 500 may be applicable to one or more of the personal computing devices 102, 202, the validation servers 106, 204, and/or the external data servers 104, 206. The computing device 500 may include processor(s) 510 (e.g., CPU, GPU, or other such processing unit(s), a memory 520, and (a) communication interface(s) 540 (e.g., a network interface) to communicate with other devices. The memory 520 may include volatile memory, such as RAM, and/or non-volatile memory, such as ROM and storage media. Examples of storage media include solid-state storage media (e.g., solid state drives and/or removable flash memory), optical storage media (e.g., optical discs), and/or magnetic storage media (e.g., hard disk drives). The aforementioned instructions (e.g., software or computer-readable code) may be stored in any volatile and/or non-volatile memory component of the memory 520. The computing device 500 may, in some embodiments, further include (an) input device(s) 550 (e.g., a keyboard, mouse, or touchscreen) and/or (an) output device(s) 560 (e.g., a display, printer). The aforementioned elements of the computing device 500 may be connected to one another through a bus 530, which may represent one or more buses. In some embodiments, the processor(s) 510 of the computing device 500 includes both a CPU and a GPU.

Instructions executable by one or more processors may be stored on a non-transitory computer-readable medium. Therefore, whenever a computer-implemented method is described in this disclosure, this disclosure shall also be understood as describing a non-transitory computer-readable medium storing instructions that, when executed by one or more processors, cause the one or more processors to perform the computer-implemented method. Examples of non-transitory computer-readable medium include RAM, ROM, solid-state storage media (e.g., solid state drives), optical storage media (e.g., optical discs), and magnetic storage media (e.g., hard disk drives). A non-transitory computer-readable medium may be part of the memory of a computer system or separate from any computer system.

It should be appreciated that in the above description of exemplary embodiments, various features are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claims require more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this disclosure.

Furthermore, while some embodiments described herein include some but not other features included in other embodiments, combinations of features of different embodiments are meant to be within the scope of the disclosure, and form different embodiments, as would be understood by those skilled in the art. For example, in the following claims, any of the claimed embodiments can be used in any combination.

Thus, while certain embodiments have been described, those skilled in the art will recognize that other and further modifications may be made thereto without departing from the spirit of the disclosure, and it is intended to claim all such changes and modifications as falling within the scope of the disclosure. For example, functionality may be added or deleted from the block diagrams and operations may be interchanged among functional blocks. Steps may be added to, or deleted from, methods described or shown herein. Steps from multiple methods described herein may be combined in any manner. Additionally, steps may be repeated, performed iteratively, or performed in a different order than as described or shown in particular herein.

The above disclosed subject matter is to be considered illustrative, and not restrictive, and the appended claims are intended to cover all such modifications, enhancements, and other implementations, which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description. While various implementations of the disclosure have been described, it will be apparent to those of ordinary skill in the art that many more implementations and implementations are possible within the scope of the disclosure. Accordingly, the disclosure is not to be restricted.

What is claimed is:

1. A computer-implemented method for electronic credential validation, comprising:
receiving, at one or more first servers, an electronic application from a client device corresponding to a user;
comparing user data points of the electronic application to electronic records corresponding to the user stored in at least one database to generate a credential score of the user;
associating the credential score with one tier of a plurality of tiers, and assigning the user to the one tier of the plurality of tiers;
transmitting an electronic notification to the client device reporting the one tier of the plurality of tiers to which the user has been assigned;
generating and assigning an electronic insignia to the user, wherein the insignia is indicative of the one tier of the plurality of tiers to which the user has been assigned;
receiving a request for the electronic credentials assigned to the user from a requesting party; and
transmitting the electronic insignia to the requesting party.

2. The computer-implemented method of claim 1, wherein the electronic records corresponding to the user include data indicative of one or more of electronic borrowing frequency, default rate(s), vendor type(s), electronic account balance, or electronic inflow-outflow information.

3. The computer-implemented method of claim 2, further including:
receiving the electronic records corresponding to the user from one or more servers corresponding to one or more third parties.

4. The computer-implemented method of claim 3, further including:
adjusting the one tier of the plurality of tiers assigned to the user based on the at least one or more first servers and one or more servers corresponding to one or more third parties receiving updated information corresponding the electronic records corresponding to the user; and
generating an updated credential score based on the updated information.

5. The computer-implemented method of claim 1, wherein each tier of the plurality of tiers includes a pre-determined tier threshold.

6. The computer-implemented method of claim 1, further including:
receiving permission settings from the user regulating access to the electronic credentials by third parties.

7. The computer-implemented method of claim 6, wherein the requesting party includes at least one third party maintaining a social media application; and
wherein the request further includes API proxy keys matching the permission settings established by the user.

8. The computer-implemented method of claim 1, further including:
providing the user with access to an online platform configured to enable networking and communication between one or more users.

9. The computer-implemented method of claim 1, wherein maintaining access to the electronic insignia requires the user to maintain assignment to at least one tier of the plurality of tiers.

10. A computer-implemented method for electronic credential validation comprising:
receiving, at one or more first servers, an electronic application and authentication credentials from a client device corresponding to a user;
determining whether the authentication credentials are valid and querying at least one database storing electronic records corresponding to the user upon determining that the authentication credentials are valid;
validating data points of the electronic application by comparing the data points to the electronic records corresponding to the user;
generating a credential score based on the validated data points by inputting the validated data points into a certification model and further associating the credential score with the user;
associating the credential score with one tier of a plurality of tiers of credential scores and assigning the user to the one tier of the plurality of tiers; and
transmitting an electronic notification to the client device reporting the one tier of the plurality of tiers to which the user has been assigned.

11. The computer-implemented method of claim 10, further including:
associating and storing the result of the determination with a profile in the at least one database.

12. The computer-implemented method of claim 10, wherein the assigning the user to the one tier of the plurality of tiers further includes:
generating and assigning an electronic insignia to the user, the insignia corresponding to the one tier of the plurality of tiers to which the user is assigned.

13. The computer-implemented method of claim 10, further including:
receiving a request from one or more servers corresponding to one or more third parties to receive the electronic credentials assigned to the user; and
transmitting the electronic insignia to the one or more servers corresponding to one or more third parties.

14. The computer-implemented method of claim 13, wherein the one or more third parties maintain a social media application, and wherein the receiving the request to receive the electronic credentials further includes:
receiving permission settings from the user, the permission settings regulating access to the electronic credentials by third parties;
wherein the request further comprises API proxy keys that match the permission settings established by the user.

15. The computer-implemented method of claim 10, wherein the storing electronic records corresponding to the user further comprises:
storing electronic records corresponding to data indicative of one or more of: bank card balance, bank account balance, credit score, or pay back rate.

16. The computer-implemented method of claim 10, wherein the electronic records corresponding to the user are received from one or more second databases corresponding to one or more financial institutions that are networked with the at least one database via a decentralized blockchain.

17. The computer-implemented method of claim 10, further comprising generating a blockchain entry in at least one first database and at least one second database.

18. The computer-implemented method of claim 10, further including providing the user with access to an online platform configured to enable networking and communication between one or more members.

19. The computer-implemented method of claim 18, wherein the online platform is maintained by the at the least one or more first servers, and maintaining access to the platform requires the user to maintain assignment to at least one tier of the plurality of tiers.

20. A computer system for electronic credential validation, comprising:
a storage device that stores instructions; and
at least one processor that executes instructions for:
receiving, at one or more first servers, an electronic application and authentication credentials from a client device corresponding to a user;
determining whether the authentication credentials are valid and querying at least one database storing electronic records corresponding to the user upon determining that the authentication credentials are valid;
validating data points of the electronic application by comparing the data points to the electronic records corresponding to the user stored in the at least one database;
generating a credential score based on the validated data points by inputting the validated data points into a certification model and further associating the credential score with the user;
associating the credential score with one tier of a plurality of tiers and assigning the user to the one tier of a plurality of tiers;
storing data corresponding to the assigned tier in the at least one database and one or more second databases networked with the at least one database via a decentralized blockchain; and
transmitting an electronic notification to the client device reporting the one tier of the plurality of tiers to which the user has been assigned.
